(19) United States
(12) Patent Application Publication
(10) Pub. No.: US 2017/0232392 A1
(43) Pub. Date: Aug. 17, 2017

(54) SYSTEMS AND METHODS FOR OFFSHORE DESALINATION AND/OR OIL RECOVERY

(71) Applicant: Porifera, Inc., Hayward, CA (US)

(72) Inventors: Erik DESORMEAUX, Berkeley, CA (US); Charles BENTON, Berkeley, CA (US)

(21) Appl. No.: 15/502,681

(22) PCT Filed: Aug. 7, 2015
(86) PCT No.: PCT/US2015/044277

§ 371 Date: Feb. 8, 2017

Related U.S. Application Data
(60) Provisional application No. 62/035,295, filed on Aug. 8, 2014.

(51) Int. Cl. B01D 61/58; B01D 61/06; C02F 1/44; B01D 61/00; B01D 61/02

(52) U.S. Cl. CPC B01D 61/58; B01D 61/002; B01D 61/025; C02F 1/445; C02F 1/441; B01D 61/06; B01D 2313/243; C02F 2103/08

(57) ABSTRACT

Separation systems are described that may include forward osmosis (FO) membranes for offshore desalination and sulfate removal. The system may use submerged FO elements (e.g. operating underwater in the ocean). The system may use FO elements in combination with high-pressure reverse osmosis (RO) elements and processes. The system may use FO elements in combination with membrane distillation elements and processes. The system may create a suction and pressurized flow from a submerged FO membrane process to a reverse osmosis system on a platform, ship, or other offshore or “along shore” structure. The product water may be used for enhanced oil recovery (EOR).

### CROSS-REFERENCE TO RELATED APPLICATIONS

This application claims the benefit under 35 U.S.C. §119 of the earlier filing date of U.S. Provisional Application 62/035,295, filed Aug. 8, 2014, which provisional application is hereby incorporated by reference in its entirety for any purpose.

### BACKGROUND

Large quantities of fresh water may be required for offshore platforms for use during drilling, in addition to personnel use. However, offshore and along shore desalination systems require a large amount of space for both pretreatment and desalination, typically performed with microfiltration/ultrafiltration (UF) and reverse osmosis systems. The cost of occupied space on offshore platforms is high for most oil and gas companies. A reduction of the space occupied by desalination systems on the platform would result in significant savings.

### SUMMARY

Examples of methods are described herein. For example, a method for offshore desalination may include providing a seawater stream to a forward osmosis system. The forward osmosis system may be submerged. The method may also include providing a draw stream to the forward osmosis system and producing a diluted draw stream.

In some examples, methods may further include maintaining a greater pressure on the seawater stream than the draw stream.

Some example methods further include using a draw recycle system, which may include a reverse osmosis system, to produce at least a portion of the draw stream from the diluted draw stream.

In some examples, the forward osmosis system may be submerged off a platform and the reverse osmosis system may be located on the platform.

Examples of systems are described herein. For example, a system may include at least one forward osmosis element submerged in a feed stream. The forward osmosis element may be configured to receive a draw stream and produce a diluted draw stream. The system may further include at least one reverse osmosis element positioned on a platform higher than the at least one forward osmosis element. The at least one reverse osmosis element may be coupled to the at least one forward osmosis element such that the at least one reverse osmosis element is configured to receive the diluted draw stream and produce a product stream and a recycled draw stream.

Example systems may further include a booster pump positioned to receive the diluted draw stream and provide a pressurized diluted draw stream to the at least one reverse osmosis element.

### BRIEF DESCRIPTION OF THE DRAWINGS

FIG. 1 is a block diagram of system components arranged in accordance with examples described herein.

FIG. 2 is a block diagram of a desalination system arranged in accordance with examples described herein.

FIG. 3 is a block diagram of a desalination system including a pressure-reducing valve arranged in accordance with examples described herein.

FIG. 4 is a block diagram of a desalination system including a hydraulic motor arranged in accordance with examples described herein.

FIG. 5 is a block diagram of another desalination system including an energy recovery device arranged in accordance with examples described herein.

### DETAILED DESCRIPTION

Certain details are set forth herein to provide a sufficient understanding of embodiments of the invention. However, it will be clear to one skilled in the art that embodiments of the invention may be practiced without various of these particular details. In some instances, well-known separation system components, fluids, fluid control components, or membrane components have not been shown in detail in order to avoid unnecessarily obscuring the described embodiments of the invention.

Examples of systems are described herein that may significantly reduce the system size and space required for offshore desalination, which may in some examples be used for enhanced oil recovery (EOR). The product water may be used for drinking water, municipal use, irrigation, drilling fluid, injection water, combinations thereof, or other high purity use in offshore and along shore environments for oil, gas, drinking water, or other applications.

Forward osmosis (FO) generally concentrates a feed stream using a semipermeable membrane and a draw stream of higher osmotic pressure. The driving force for water transfer from the feed to the draw typically is the difference in the osmotic pressure. Desalination separation systems with FO may treat seawater, including dirty and contaminated seawater. The source of seawater may be in any location in a sea or the ocean in addition to inland brackish and non-saline offshore environments. The FO process concentrates the seawater as is and does not generally thermally alter, degrade, or pressurize the stream. The FO membrane may remove sulfur, sulfates, boron, and other constituents not desired during EOR processes, as pure water transfers from the feed stream to the draw stream via osmosis. To produce low salinity water suitable for drilling (e.g. EOR), the nearly pure draw solution may be treated by reverse osmosis (RO), ultra high pressure RO, multistage RO, or other separation processes (e.g., membrane distillation (MD), thermally switchable draw solutes, or thermal evaporator). An advantage of an FO system combined with RO compared to traditional RO in some examples is that the chemical composition of the draw solution may be used to control the permeate composition. For example, if a low sodium permeate is desired, a magnesium chloride draw may be used.

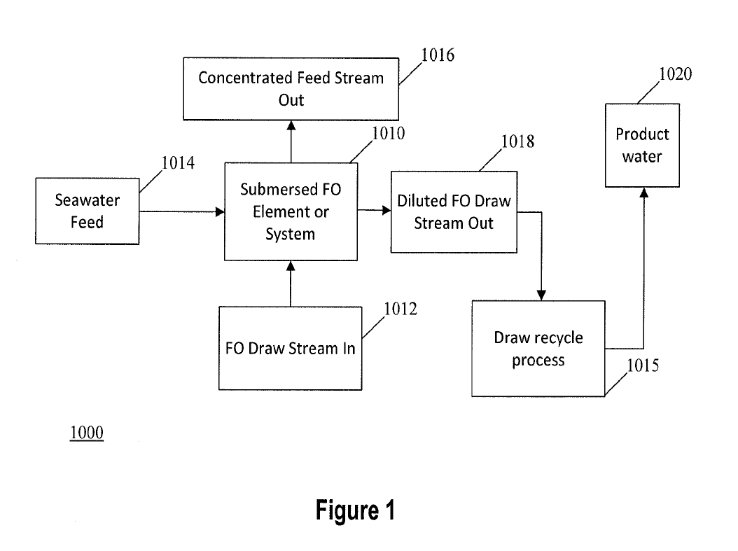

FIG. 1 is a block diagram of system components arranged in accordance with examples described herein. The system 1000 includes a submersed FO element or FO system 1010 and a draw recycle system 1015. The FO system 1010 may receive a draw stream 1012 at a draw inlet and a feed stream 1014 (e.g. seawater) at a feed inlet, and produce a concentrated feed stream 1016 at a feed outlet and a diluted draw stream 1018 at a draw outlet. The draw recycle system 1015 may receive the diluted draw stream 1018 at an inlet and provide a product stream 1020 (e.g. water) at a first outlet and a recycled draw stream at a second outlet, which may be provided back to the draw inlet of the FO element or FO system 1010.

During operation, a feed stream 1014 (e.g. a seawater stream) may be provided to the FO system 1010, which may include at least one FO element. A draw stream 1012 may also be provided to the FO system 1010, including the at least one FO element. The FO system 1010, including at least one FO element, may produce diluted draw stream 1018. The pressure of the feed stream 1014 may be maintained at a greater pressure than the draw stream 1012, which may facilitate improved operation of the FO system 1010 including at least one FO element.

The draw recycle system 1015 may receive the diluted draw stream 1018 and provide a recycled draw stream. In this manner, at least a portion of the draw stream 1012 may be provided from the draw recycle system 1015.

An FO element generally refers to a unit of a forward osmosis system capable of receiving a draw and feed solution, presenting those solutions to a membrane, and producing a product stream using forward osmosis. An FO system may include multiple FO elements operating in parallel and/or series to provide a particular throughput.

In some examples, the FO system 1010 may include one or more FO elements which may not be plumbed (e.g. the elements may not be enclosed and have confined fluid inlets). In some examples, the FO system 1010 may simply be open to the feed stream in which the FO system 1010 is submerged (e.g. seawater). While the FO elements may have a draw inlet isolated from the paths open to the feed stream, the elements may not require a plumbed feed inlet.

Examples of the FO system 1010, including FO elements and FO membranes that may be utilized in the FO systems described herein may be found in, for example, U.S. patent application Ser. No. 13/200,780, filed Sep. 30, 2011, entitled “Thin Film Composite Membranes For Forward Osmosis, and Their Preparation Methods,” U.S. patent application Ser. No. 14/137,903 filed Dec. 20, 2013 entitled “Separation systems, elements, and methods for separation utilizing membrane envelopes and spacers,” and PCT Application No. PCT/US2014/029332, filed Mar. 14, 2014 entitled “Advancements in Osmotically Driven Membrane Systems Including Multi-stage Purification.” All afore-mentioned applications are hereby incorporated by reference in their entirety for any purpose.

In some examples, the FO elements may be flat sheet (e.g., Porifera PFO

Elements), spiral wound (e.g., HTI), or hollow fiber (e.g., Toyobo type). The element may be a spiral wound or a plate and frame or a hollow fiber element with a forward osmosis membrane. The membrane may be cellulose acetate or a thin-film composite membrane with a polyamide selective layer on a polyamide support with an embedded mesh. The FO element may or may not have a spacer. The FO element may be a submersible FO element (e.g., PFO-20SUB). The element may have low headloss, as measured in the PFO-20SUB element. The submersible FO element may be baffled and have increased surface velocities and FO performance. In some examples the FO element may be operated with the feed pressure exceeding the draw pressure to maintain membrane active area and integrity.

In some examples, the FO element may include a plurality of membrane plate assemblies. Each of the membrane plate assemblies may include a spacer plate having a spacing region. The spacer plate may at least partially define a first opening and a second opening. The spacer plate may include a first surface having a first bonding area and an opposing second surface having a second bonding area. The membrane plate assemblies may each include a first membrane bonded to the first surface at the first bonding area. The membrane plate assemblies may each include second membrane bonded to the second surface at the second bonding area. The membrane plate assemblies may form a stack, with adjacent membrane plate assemblies in the stack having alternating orientations. The first surface and the second surface may have a staggered position with respect to one another. The first opening of the spacer plate may be in fluid communication with a region between the first and second membranes defining a first flow path. The separation system may further include support plates coupled to hold the membrane elements in a stack, wherein at least one of the support plates defines at least one fluid port. In some examples, the FO element may be a single element or an array of elements.

In some examples the system 1000, which may be a desalination system, may be operated with a draw stream 1012 (e.g. draw solution) optimized for enhanced oil recovery (EOR) chemistry. The feed stream 1014 may be a seawater stream or brackish water stream in some examples. The FO system 1010 may be submerged in the feed stream 1014, which may not require dedicated space on a platform, such as an oil platform which may also support an oil rig. Instead, the FO system 1010 may be submersed in seawater. The draw stream 1012 (e.g. draw solution) may include water and a draw solute. The draw solute may be any draw solute, but may be preferably an inorganic salt. Examples of draw solute include sodium chloride, magnesium chloride, and magnesium sulfate. In some examples, magnesium chloride or calcium chloride may be used for EOR for increased magnesium or calcium concentration in the permeate/drilling fluid for preferred EOR chemistry. Magnesium sulfate may not be preferred with EOR because sulfate may generally be not desirable for these applications.

The draw recycle system 1015 may be implemented using a reverse osmosis (RO) system, which may include one or more reverse osmosis (RO) elements. The RO elements may be standard RO elements, nanofiltration (NF), ultrahigh pressure (UHP) or high-pressure SWRO. The RO elements may include a pressure vessel. The diluted draw stream 1018 may be processed with the draw recycle system 1015 (e.g. NF, RO, multistage RO, ultra-high pressure RO, or membrane distillation (MD)) to create a product water 1020, which may be used, for example, for drilling and injection fluid.

The draw recycle system 1015 in some examples may be located on a platform, such as an oil platform which may also support an oil rig. By utilizing forward osmosis to produce diluted draw stream 1018, the requirements on the draw recycle system 1015 may be lessened because not as much desalination is required to produce the product stream 1020 from the diluted draw stream 1018 as directly from the seawater feed 1014 as a portion of the draw stream may be a drilling fluid additive and may not require draw recycling. In some examples, the forward osmosis system may produce a clean draw solution that may be recycled with improved efficiency (e.g., higher flux, higher pressure) compared to conventional RO. Accordingly, the draw recycle system (e.g. NF, RO, multistage RO, ultra-high pressure RO, or membrane distillation) may not be as large as it otherwise would need to be to produce the product stream from the feed stream without the use of forward osmosis. In some examples, the draw recycle system may be reduced in size and the forward osmosis system 1010 may be submersed and the total area of a platform required may be desirably reduced.

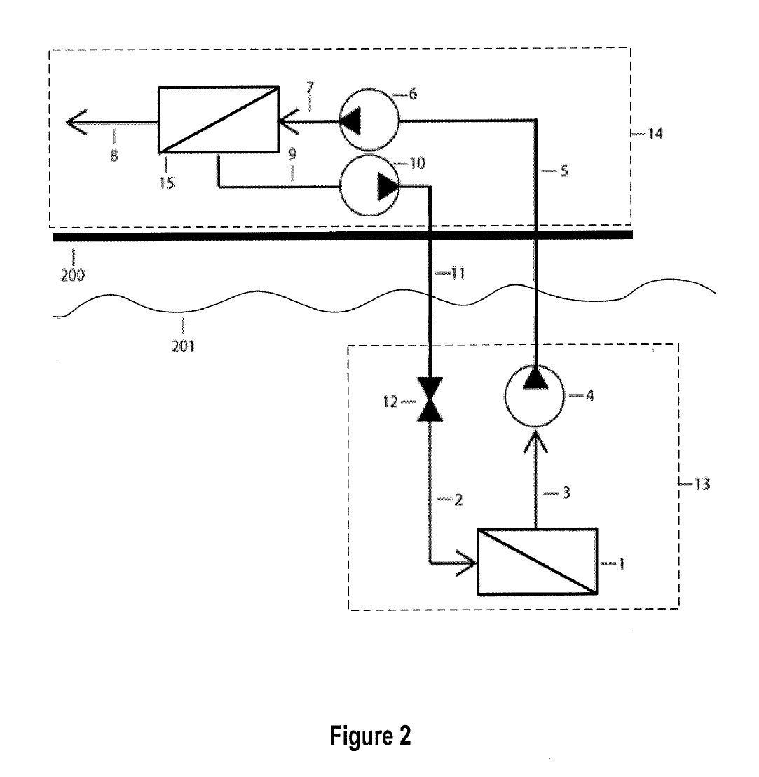

In some examples, water may be produced by a desalination system described herein, and methods for offshore desalination may be provided. A block diagram of an example desalination system is illustrated in FIG. 2. The desalination system of FIG. 2 may be used to implement the system 1000 of FIG. 1. The desalination system of FIG. 2 may be operated from oil platform 200 over seawater 201 (e.g. 32,000 ppm seawater). The desalination system may include an FO system 13 located off the oil platform 200, such as submerged in seawater, e.g. at twenty meters below the seawater surface, and RO system 14 on oil platform 200, e.g. twenty meters above the seawater surface. The FO system 13 may be used to implement the submerged FO system 1010 of FIG. 1, and the submerged FO system 1010 of FIG. 1 may be used to implement the FO system 13 of FIG. 2. The RO system 14 may be used to implement the draw recycle system 1015 of FIG. 1. The FO system 13 may be at any depth and the RO system may be at any height in other examples. FO system 13 may include, but is not limited to: FO membrane element 1, booster pump 4, valve 12, and streams that circulate from the submerged FO system to the on-platform RO system 14. RO system 14 may include but is not limited to: RO element 15, high-pressure pump 6, hydraulic motor 10, permeate stream 8, and streams that circulate from the RO system 14 to FO system 13. Submerged FO element 1 operating at 10% recovery in FO system 13 may receive draw stream 2 (e.g., 94,800 ppm NaCl, 24,000 m³/day) and produce diluted draw stream 3 (e.g., 47,400 ppm NaCl, 48,000 m³/day). The FO element may be any FO element or array of elements, including but not limited to: spiral wound or more preferably plate and frame or submersible plate and frame. Water may permeate from seawater to the draw across an FO membrane. Draw stream 2 (e.g. 28 psi) may be at lower pressure than seawater 201 (e.g. 30 psi) to prevent reduction of active membrane area or damage to the membrane seal. Diluted draw stream 3 (e.g. 27 psi) may be pressurized by booster pump 4 to produce pressurized diluted draw stream 5 (e.g. 95 psi) and provide sufficient net positive suction head at the high-pressure RO feed pump 6 thereby ensuring that the pressure on the draw side of the membrane is lower than the pressure on the feed side of the membrane even if the elevation of the FO elements changes. Booster pump 4 may be at the seawater surface or any depth below seawater surface (e.g. the booster pump may be submerged in the seawater feed solution). Booster pump 4 may be a positive displacement pump or centrifugal pump or any other hydraulic pump. Pressurized diluted draw stream 5 may have a pressure drop of 60 psi from booster pump 4 to high-pressure pump 6, for example. Pressurized diluted draw stream 5 (e.g. 35 psi) may be pressurized by high-pressure pump 6 to produce high-pressure diluted draw stream 7 (e.g. 800 psi). High-pressure pump 6 may be a hydraulic pump or combination of hydraulic pump and energy recovery device (e.g., ERI PX). RO element 15 may receive high-pressure diluted draw stream 7 and may produce permeate stream 8 (e.g., 300 ppm NaCl, 24,000 m³/day) and high-pressure draw stream 9 (e.g. 800 psi, 94,800 ppm NaCl, 24,000 m³/day). Hydraulic motor 10 may receive high-pressure draw stream 9 and produce low-pressure draw stream 11 (e.g. 5 psi). Hydraulic motor 10 may be a hydraulic motor or an energy recovery device in other examples. Valve 12 may receive low pressure draw stream 11 (e.g. 65 psi) and produce draw stream 2 (e.g. 28 psi).

In this example, the desalination system may reduce the platform space needed for desalination by 70% compared to “conventional pretreatment (sand filters or UF)+RO” processes and 15% compared to “minimal pretreatment+RO” processes when minimal pretreatment is considered feasible. Table 1 provides a summary of the amount of membrane area installed above and below the water surface for this example.

TABLE 1
Comparison of “On-Platform” Space Requirements

| Process | Assumptions | Pretreatment | RO | On-platform space |
|---|---|---|---|---|
| FO + RO | System recovery: 10% | 2080 40-m² FO | 700 42-m² | Smallest |
| | RO recovery: 50% | elements installed | SWRO elements | footprint; >50% |
| | FO Flux: 12 lmh | under the platform | installed on | platform |
| | SWRO Flux: 34 lmh | (cartridge filters | the platform | space savings |
| | | not necessary) | | |
| UF + RO | System recovery: 40% | 1667 30-m2 UF | 1,587 42-m2 | >70% larger |
| | RO recovery: 50% | elements and 5- | SWRO elements | footprint than |
| | UF Flux: 40 lmh | micron cartridge | installed on | FO + RO |
| | SWRO Flux: 15 lmh | filters installed | the platform | |
| | | on the platform | | |
| Minimal | System recovery: 40% | 5-micron cartridge | 1,984 42-m2 | >50% larger |
| pretreatment + | RO recovery: 40% | filters installed | SWRO elements | footprint than |
| RO | SWRO Flux: 12 lmh | on the platform | installed on | FO + RO |
| | | | the platform | |

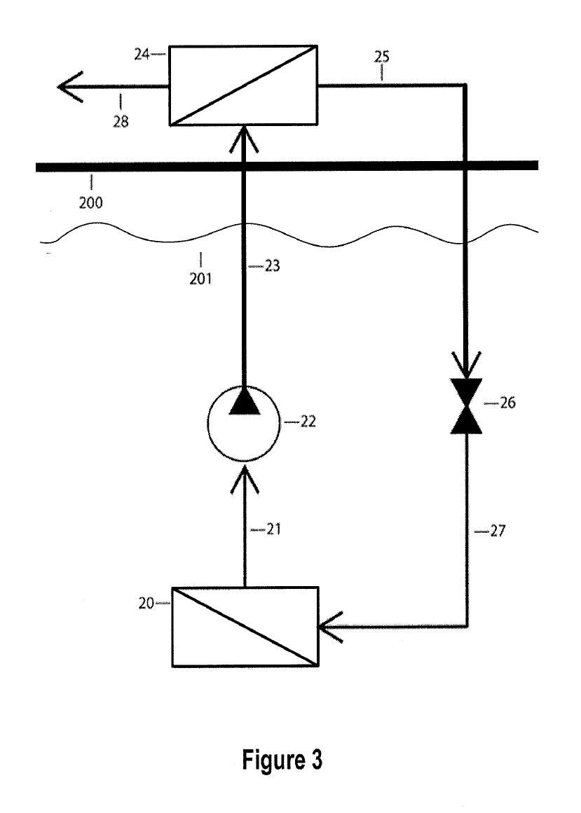

Additionally, the system may use different types of energy recovery devices (ERD's), valves, pumps, and motors to operate submerged FO elements at a negative pressure differential. This arrangement may facilitate maintaining the draw pressure lower than the feed pressure which may be required in examples of FO systems described herein. Therefore, unique solutions may be needed to maintain the proper pressure differentials in the system. Block diagrams illustrate three examples that may be used to facilitate proper offshore (e.g. submerged) FO operation in FIGS. 3, 4, and 5.

In some examples, the desalination system may utilize a pressure-reducing valve (PRV) on the draw inlet into the FO elements to reduce pressure coming from the source on the platform or structure above. A block diagram illustrates a desalination system with a PRV in FIG. 3. An FO element 20 may receive draw stream 27 and produce diluted draw stream 21. Booster pump 22 may receive diluted draw stream 21 and produce high-pressure diluted draw stream 23. RO system 24 may receive high-pressure diluted draw stream 23 and produce permeate stream 28 and high-pressure draw stream 25. Back pressure valve 26 may receive high pressure draw stream 25 and produce draw stream 27. The back pressure valve may be implemented using a butterfly valve, a needle valve, a globe valve, or any other pressure reducing valves.

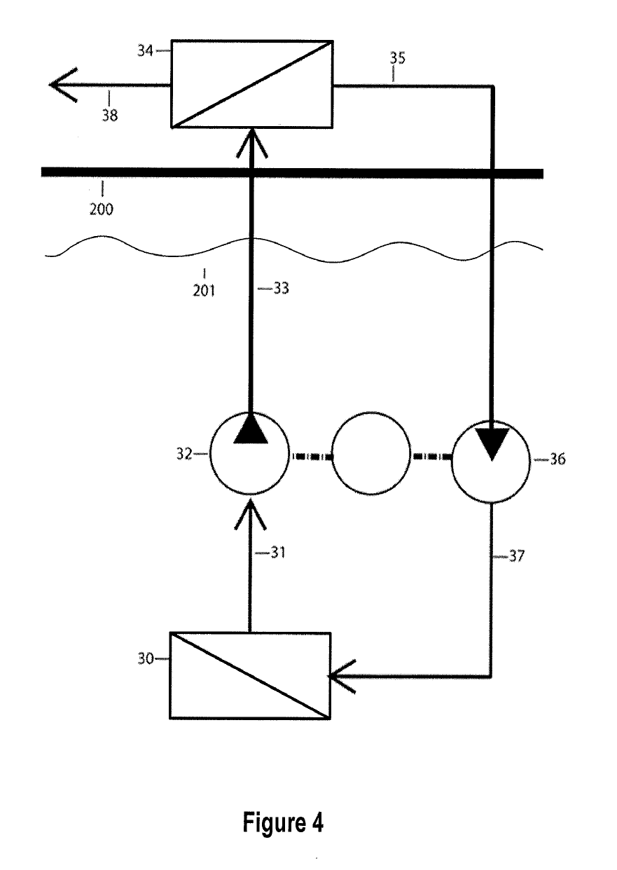

In some examples, the desalination system may utilize a hydraulic motor serving as an ERD that may capture and effectively reduce pressure coming from the source on the platform or structure above which may be mechanically transferred to a hydraulic pump, pumping the draw stream up to the platform. A block diagram illustrates a desalination system with a hydraulic motor in FIG. 4. FO element 30 may receive draw stream 37 and produce diluted draw stream 31. Booster pump 32 may receive diluted draw stream 31 and produce high-pressure diluted draw stream 33. RO system 34 may receive high-pressure diluted draw stream 33 and produce permeate 38 and high-pressure draw stream 35. Hydraulic motor 36 may receive high-pressure draw stream 35 and produce draw stream 37. Hydraulic motor 36 may be a hydraulic motor-hydraulic pump assembly. The hydraulic motor-hydraulic pump assembly may include a Pearson pump or a Danfoss APP/APM in some examples. An electric motor may be used to supply additional power to the hydraulic pump. The hydraulic motor-hydraulic pump assembly may be at the seawater surface, at the FO system depth, or any depth in between the seawater surface and FO system depth.

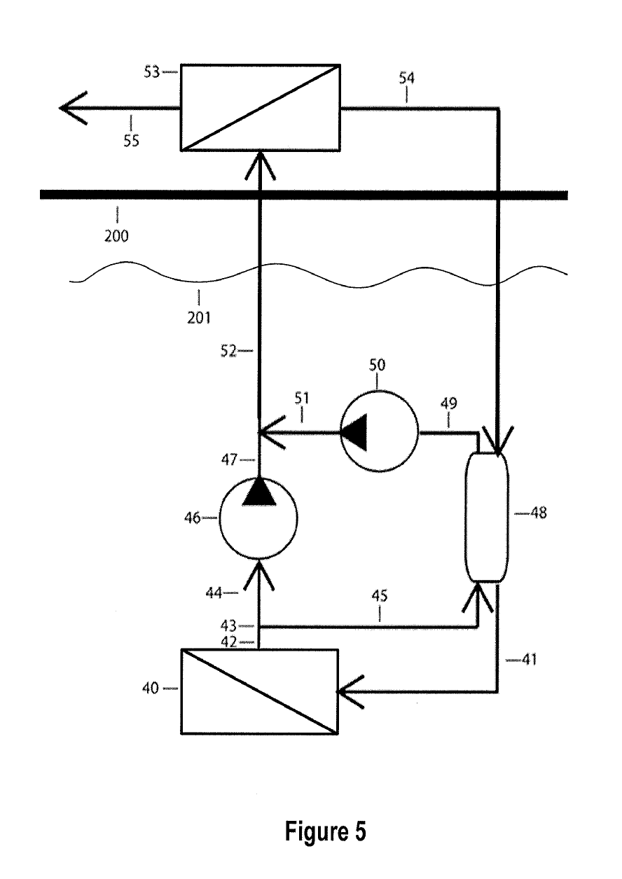

In some examples, the desalination system may utilize an energy recovery device (ERD) that may capture and effectively reduce pressure coming from the RO system on the platform 200 or structure above. This hydraulic power may be transferred to the draw outlet and this pressure combined with the pressure from a booster pump to boost the draw stream back to the platform or structure above. A block diagram illustrates a desalination system with an ERD in FIG. 5 at an example depth. FO element 40 may receive draw stream 41 (e.g., 28 psi) and produce a first diluted draw stream 42 (e.g., 27 psi). T-junction 43 may receive a first diluted draw stream 42 and divide the first diluted draw stream into a second diluted draw stream 44 and a third diluted draw stream 45. Lift-pump 46 may receive a second diluted draw stream 44 (e.g., 27 psi) and produce a first high-pressure diluted draw stream 47 (e.g., 95 psi). The lift-pump 46 may be an in-line multistage centrifugal pump. ERD 48 may receive a third diluted draw stream 45 (e.g., 27 psi) and produce an intermediate-pressure diluted draw stream 49 (e.g., 63 psi). A booster pump 50 may receive an intermediate-pressure diluted draw stream 49 and produce a second high-pressure diluted draw stream 51 (e.g., 95 psi). The booster pump 50 may be an in-line centrifugal booster pump (e.g., ERI High Flow Circulation Pump). A first high-pressure diluted draw stream 47 may combine with a second high-pressure diluted draw stream 51 to produce a third high-pressure diluted draw stream 52 (e.g., 95 psi). RO element 53 may receive the third high-pressure diluted draw stream 52 and produce permeate 55 (e.g., 5 psi) and high-pressure draw stream 54 (e.g., 5 psi). High pressure draw stream 54 may have increasing pressure from 5 psi to 65 psi with increasing depth below seawater 201. ERD 48 may receive high-pressure draw stream 54 (e.g., 65 psi) and produce draw stream 41 (e.g., 28 psi). The energy recovery device may include an integrated turbo-type pressure booster, ERI Pressure Exchanger or any other energy recovery device.

1. A method for offshore desalination, the method comprising:
providing a seawater stream to a forward osmosis system, wherein the forward osmosis system is submerged in seawater;
providing a draw stream to the forward osmosis system from a height of at least 20 meters above a surface of the seawater to form a pressurized draw stream:
reducing pressure of the pressurized draw stream to produce a draw stream having a lower pressure than the pressurized draw stream;
producing a diluted draw stream.

2. The method of claim 1, further comprising maintaining a greater pressure eon the seawater stream than the draw stream.

3. The method of claim 1, further comprising using a draw recycle system to produce at least a portion of the draw stream from the diluted draw stream.

4. The method of claim 3, wherein the draw recycle system comprises a reverse osmosis system.

5. The method of claim 3, further comprising producing a product stream using the draw recycle system.

6. The method of claim 4, wherein the forward osmosis system is submerged off a platform and wherein the reverse osmosis system is located on the platform.

7. The method of claim 6, wherein the platform comprises an oil platform.

8. The method of claim 6, further comprising pumping the diluted draw stream up to the reverse osmosis system from the submerged forward osmosis system.

9. The method of claim 5, further comprising using the product for enhanced oil recovery.

10. (canceled)

11. A system comprising:
at least one forward osmosis element submerged in a feed stream, the forward osmosis element configured to receive a draw stream and produce a diluted draw stream;
at least one reverse osmosis element positioned on a platform at least 20 meters higher than the feed stream the at least one forward osmosis element is submerged in, the at least one reverse osmosis element coupled to the at least one forward osmosis element such that the at least one reverse osmosis element is configured to receive the diluted draw stream and produce a product stream and a recycled draw stream; and
a pressure reducing device disposed between the at least one forward osmosis element and the at least one reverse osmosis element the pressure reducing device being configured to reduce a hydraulic pressure of the recycled draw stream prior to introduction of the same into the at least one forward osmosis element.

12. The system of claim 11, wherein the feed stream comprises seawater and wherein the product stream comprises water suitable for enhanced oil recovery.

13. The system of claim 11, further comprising a booster pump positioned to receive the diluted draw stream and provide a pressurized diluted draw stream to the at least one reverse osmosis element.

14. The system of claim 13, wherein the booster pump is submerged in the teed stream.

15. The system of claim 13, wherein the pressure reducing device includes a hydraulic motor configured to receive the recycled draw stream and reduce the hydraulic pressure of the recycled draw stream.

16. The system of claim 15, wherein the hydraulic motor comprises a hydraulic motor-hydraulic pump assembly.

17. The system of claim 11, wherein the pressure reducing device includes a pressure-reducing valve coupled to an inlet of the at least one forward osmosis element.

18. The system of claim 11, wherein the diluted draw stream comprises a first diluted draw stream, the system further comprising:
a T-junction positioned to divide the first diluted draw stream into a second diluted draw stream and a third diluted draw stream;
a lift-pump configured to receive the second diluted draw stream and provide a first high-pressure diluted draw stream;
wherein the pressure reducing device includes an energy recovery device configured to receive the third diluted draw stream and provide an intermediate-pressure diluted draw stream;
a booster pump configured to receive the intermediate-pressure diluted draw stream and provide a second high-pressure diluted draw stream;
wherein the recycled draw stream includes a high pressure recycled draw stream, and the at least one reverse osmosis element is configured to receive the first and second high-pressure diluted draw streams and provide the high-pressure recycled draw stream; and
wherein the energy recovery device is further configured to receive the high pressure recycled draw stream, reduce the hydraulic pressure of the high pressure recycled draw stream, and provide the recycled draw stream to the at least one forward osmosis element.

19. The system of claim 18, wherein the lift-pump comprises an in-line multistage centrifugal pump.

20. The system of claim 18, wherein the energy recovery device comprises a turbo-type pressure booster.

21. The system of claim 11, further comprising a valve disposed between the energy recovery device and the at least one forward osmosis element, the valve being configured to further lower the pressure of the recycled draw stream prior to introduction of the same into the at least one forward osmosis element.

22. The method of claim 1, wherein reducing pressure of the pressurized draw stream is effective to cause the draw stream to have a lower hydrostatic pressure than the feed stream in the at least one forward osmosis element effective to create a lower pressure on a draw side than a feed side of the at least one forward osmosis element.
